(19) United States
(12) Patent Application Publication
(10) Pub. No.: US 2020/0366045 A1
(43) Pub. Date: Nov. 19, 2020

(54) STRETCHER-FREE ULTRAFAST LASER SYSTEM EMPLOYING A PICOSECOND FIBER OSCILLATOR AND POSITIVELY CHIRPED INTRACAVITY MIRRORS FOR PULSE ELONGATION

(71) Applicant: Femto Blanc Inc., Lambertville, NJ (US)

(72) Inventors: Vladimir S. Ban, Princeton, NJ (US); Michael B. Orozco, Santa Ana, CA (US)

(73) Assignee: Femto Blanc Inc., Lambertville, NJ (US)

(21) Appl. No.: 16/864,642

(22) Filed: May 1, 2020

Related U.S. Application Data
(60) Provisional application No. 62/841,752, filed on May 1, 2019.

(51) Int. Cl. H01S 3/00; H01S 3/094; H01S 3/081; H01S 3/16; H01S 3/23

(52) U.S. Cl. CPC H01S 3/0057; H01S 3/0064; H01S 3/094042; H01S 3/235; H01S 3/1618; H01S 3/163; H01S 3/0816

(57) ABSTRACT

Disclosed is a laser system that incudes a chirped fiber oscillator, a laser amplifier, and a compressor. The laser amplifier includes a laser Faraday isolator. The fiber oscillator output is directly coupled to the laser Faraday isolator.

### CROSS-REFERENCE TO RELATED APPLICATIONS

This application claims priority from U.S. Provisional Application No. 62/841,752, filed May 1, 2019, the contents of which are hereby incorporated by reference herein.

### BACKGROUND

Ultrafast lasers are finding application in a wide variety of fields. They are widely used in cataract operations and other ophthalmic procedures, as well as in other medical fields. They are also used in machining the world's hardest and strongest materials, e.g., drilling and cutting diamonds, silicon carbide, hard metals, etc.

Ultrafast lasers are expensive and sensitive systems, requiring frequent adjustments and complicated maintenance, they are prone to performance deterioration and need highly qualified personnel to operate them.

In order to amplify ultrafast pulses a process known as chirped pulse amplification is usually utilized. This process requires that the pulsewidth of a seed laser be temporally stretched before being injected into a laser amplifier and then recompressed once amplification has been accomplished.

Conventionally, the stretching of a laser pulse is accomplished through the use of reflective gratings in an optical setup commonly referred to as a Stretcher. Unfortunately, Stretchers are inherently lossy and the means by which they chirp the pulse can cause distortion of the laser beam. In order to avoid these losses and beam distortion we have designed, and built, a novel ultrafast laser system which does not utilize a conventional Stretcher. Instead, we begin with a pre-chirped seed laser which produces a picosecond laser pulse and have designed a novel regenerative amplifier with intracavity positive chirp mirrors which effectively stretch the laser pass with each round trip through the cavity. This greatly simplifies alignment and significantly lowers the probability of damaging optical components by lowering peak powers in the laser cavity. The result is a more compact and highly reliable laser system which is less susceptible to misalignment, field serviceable, and provides higher up-time with a lower cost of operation.

### SUMMARY

Conventional ultrafast laser systems are composed of a laser oscillator, stretcher, pulse-picker, laser amplifier, and an optical pulse compressor due to the use of a femtosecond seed laser. Our design eliminates the need for a stretcher by utilizing a picosecond pulsewidth laser oscillator and positive GDD, (Group Delay Dispersion), intracavity mirrors. Instead, we begin with a chirped fiber oscillator (<2 ps) which is routed into the laser amplifier cavity and then compressed using a single transmissive grating.

### BRIEF DESCRIPTION OF THE DRAWINGS

FIG. 1 is a diagram of a simplified laser system design.

FIG. 2 depicts the components of a regenerative laser amplifier cavity.

FIG. 3 provides a dispersion curve of positive GDD mirrors utilized in laser cavity.

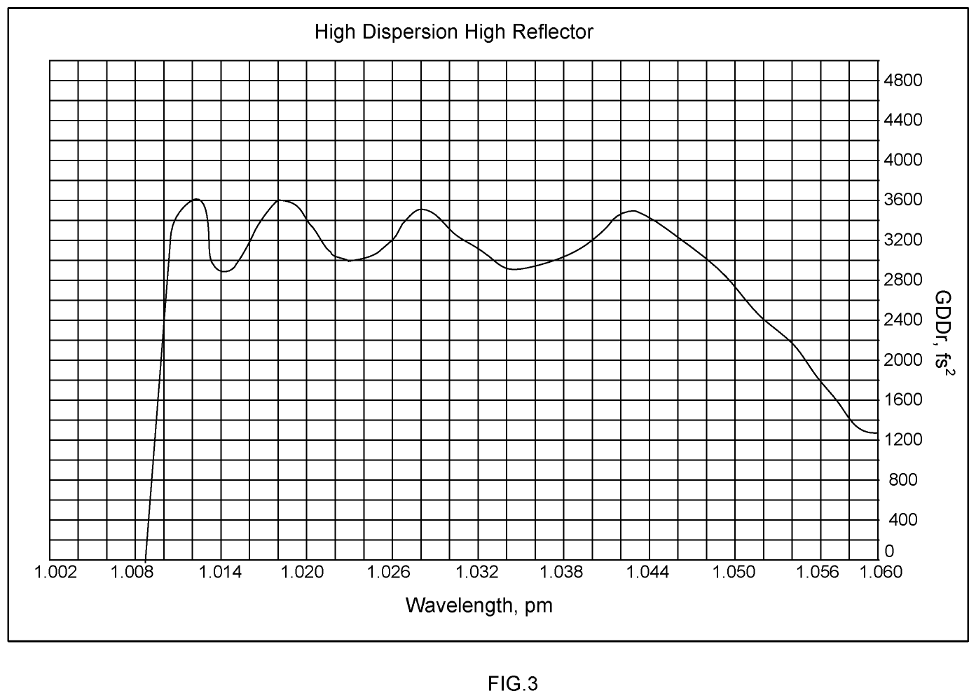

FIG. 4 provides a comparison of intracavity peak powers of pulses stretched by a Chirped Volume Bragg Grating (CVBG) and Positive GDD mirrors (Chirped Optics).

FIG. 5 provides a mode quality (M2) plot of the laser cavity.

### DETAILED DESCRIPTION

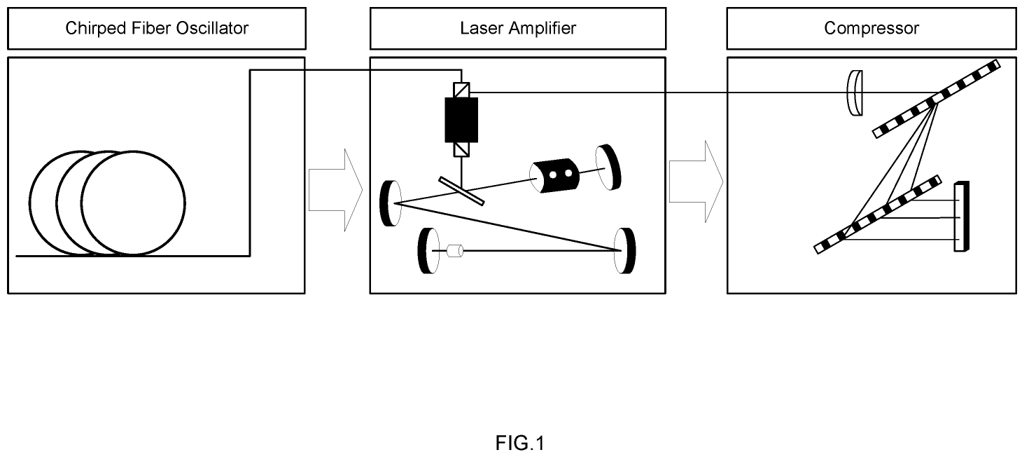

FIG. 1 is a diagram of a simplified laser system design. As shown, the laser system includes a chirped fiber oscillator, a laser amplifier, and a compressor.

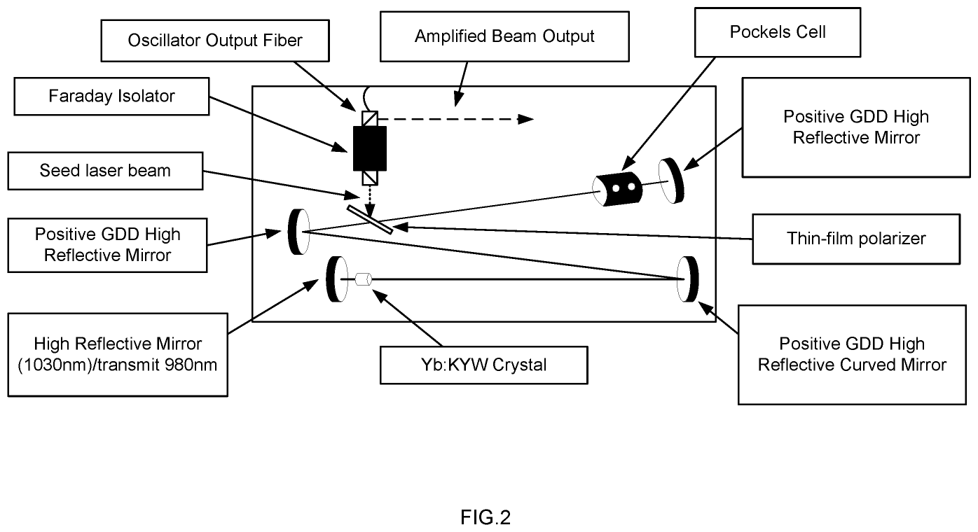

The fiber oscillator output is directly coupled to the laser Faraday isolator to avoid the possibility of misalignment as shown in FIG. 2, which depicts the components of a regenerative laser amplifier cavity.

As shown in FIG. 2, multiple positive Group Delay Dispersion (GDD) mirrors may be utilized in the cavity. The coating of the mirrors was custom designed for this application and each one provides ˜4000 fs² of dispersion to the input laser pulse per reflection.

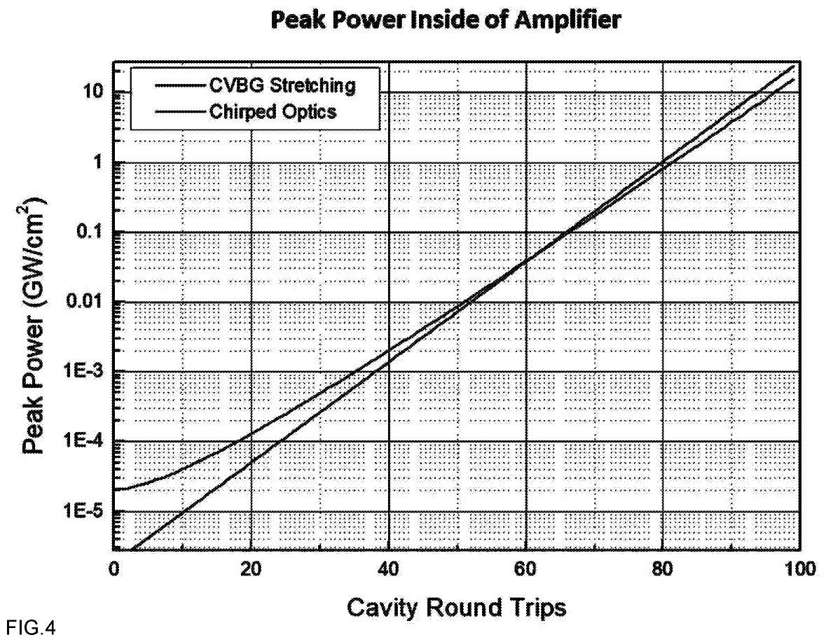

The seed laser beam reflects offs the positive GDD mirrors as it cycles through the laser amplifier cavity. During each cycle through the amplifier cavity, or “round trip,” the seed laser pulse is amplified. In order to reach the desired pulse energy, the seed laser must complete numerous round trips. The peak power of the laser pulses as it cycles through the cavity would damage the cavity optics if it was not temporally stretched. The positive GDD mirrors accomplish the stretching and keep the intracavity peak powers at levels comparable to lasers where a chirped volume Bragg grating (CVBG) is used for pulse stretching prior to amplification as shown in FIG. 4.

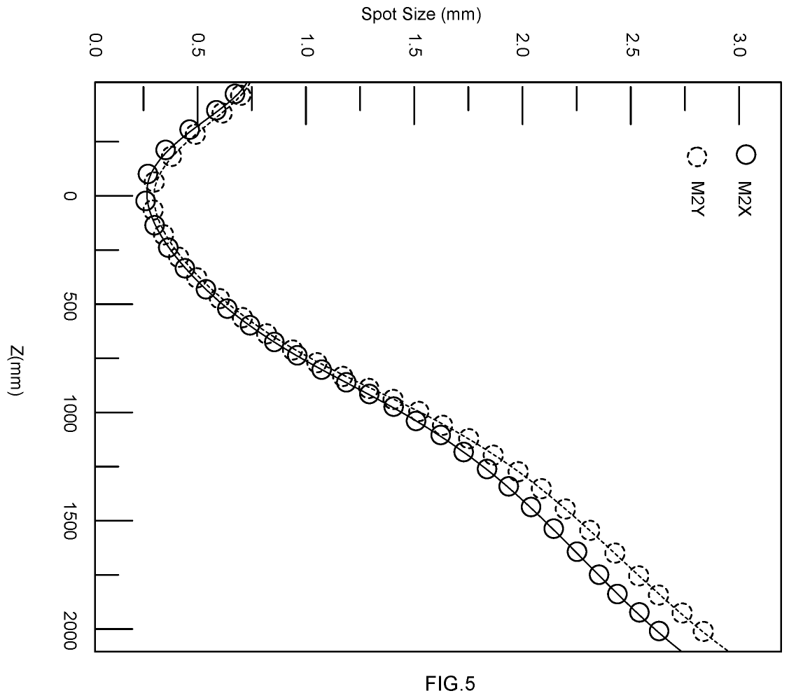

However, unlike a system utilizing a CVBG, the input and output beam profiles of our laser are not compromised by the stretching and compressing optics. Through the use of the positive GDD mirrors for stretching and compressing by several passes through a single, conventional, transmission grating our beam profile is dependent solely upon our laser amplifier cavity design. This design of delivers a highly symmetric beam with a mode quality (M2) value less than 1.3 as shown in FIG. 5.

In addition to superior beam quality the use of positive dispersion mirrors also allows for our laser to operate and dynamically switch repetition rate from single-shot to 1 MHz without compromising laser performance (see Table 1 below, which provides laser output energy at operating repetition rates).

| Repetition Rate | Max. Energy | Peak Power |
|---|---|---|
| (kHz) | (μJ) | (MW) |
| 20* | 150.0 | 300.0 |
| 40 | 75.0 | 150.0 |
| 60 | 50.0 | 100.0 |
| 80 | 37.5 | 75.0 |
| 100 | 30.0 | 60.0 |
| 200 | 15.0 | 30.0 |
| 300 | 10.0 | 20.0 |
| 400 | 7.5 | 15.0 |
| 500 | 6.0 | 12.0 |
| 500 | 5.0 | 10.0 |
| 700 | 4.3 | 8.6 |
| 800 | 3.8 | 7.5 |
| 900 | 3.3 | 6.7 |
| 1000 | 3.0 | 6.0 |

Finally, as a result of our novel design and incorporation of experience our compact design can operate over a large range of environmental conditions and repetition rates (see Table 2 below, which provides laser specifications of novel ultrafast laser system).

| | |
|---|---|
| Wavelength (nm) | 1030 (+/−2) |
| Average Power (W) | ≥3 (Low Cost Model) |
| Pulse Duration (fs) | <500 |
| Repetition Rate (kHz) | SS-1000 |
| Mode Quality (M2) | <1.35 |
| Pulse to Pulse Stability | 1% over 10 minutes |
| Pulse Contrast | >20:1 |
| Start Up Time (Warm) | 2 minutes |
| Operating Temperature | 15 C.-40 C. |
| Humidity | 90% noncondensing |
| Cooling | Water (closed-loop) |
| Power Requirements | 110 V/15 A (50 Hz/60 Hz) |
| Laser Head Dimensions | <450 mm × 350 mm × 220 mm |
| Weight (kg) | <22 |

What is claimed is:

1. A laser system comprising:
a chirped fiber oscillator;
a laser amplifier comprising a laser Faraday isolator; and
a compressor,
wherein the fiber oscillator output is directly coupled to the laser Faraday isolator.
